(19) United States
(12) Patent Application Publication
(10) Pub. No.: US 2015/0327683 A1
(43) Pub. Date: Nov. 19, 2015

(54) SUPPORT ASSEMBLY

(71) Applicant: CHALLENGER HARDWARE COMPANY, Brooklyn Heights, OH (US)

(72) Inventors: Joseph M. Ross, Pepper Pike, OH (US); Timothy W. Kaiser, Sedan, KS (US)

(21) Appl. No.: 14/712,070

(22) Filed: May 14, 2015

Related U.S. Application Data
(60) Provisional application No. 61/993,075, filed on May 14, 2014.

(51) Int. Cl. A47C 7/54; B60N 2/46

(52) U.S. Cl. CPC A47C 7/543; B60N 2/4606

(57) ABSTRACT

A support assembly for supporting an element and for rotating that element between a first position and a second position. The support assembly may be used to support an armrest pad and is suitable for use on watercraft. The assembly includes an arm extending from a knuckle assembly. The arm engages the armrest pad, while the knuckle assembly is disposed in a pocket of a cap assembly. The knuckle assembly rotates within the pocket to move the arm and armrest pad between the first and second positions. A pair of washers and a bushing is abutted with an end of the arm to form the knuckle assembly. The thickness of the washers facilitates a frictional engagement inside the pocket between the knuckle assembly and the cap assembly. Stops are provided to limit the rotational travel of the knuckle within the pocket.

### CROSS-REFERENCE TO RELATED APPLICATIONS

This application claims the benefit of U.S. Provisional Patent Application Ser. No. 61/993,075, filed May 14, 2014, the entire specification of which is incorporated herein by reference.

### BACKGROUND OF THE INVENTION

1. Technical Field

The present invention relates generally to a support assembly. More particularly, the invention relates to a device and method for supporting an element such as an armrest pad. Specifically, the invention relates to a support assembly which uses friction to provide resistance for moving the support assembly between a first position and a second position.

2. Background Information

Support assemblies may be used for a variety of purposes, including supporting elements such as armrest pads. A typical support assembly for a movable armrest pad includes a fastener or threaded nut which extends through a portion of the pad itself and into some type of element that provides a rotational function for the armrest. In a marine environment, such as on a watercraft, any exposed hardware or fixtures may come into contact with either fresh water or salt water. Either type of water is extremely corrosive to certain materials and may therefore significantly impact the life of hardware used to secure armrest pads to the associated armrests.

### SUMMARY

There is therefore a need in the art for providing a mechanism which provides support to an element such as an armrest pad while minimizing the exposure of hardware utilized therewith to elements such as water which may corrode that hardware over time.

A support assembly for supporting an element and for rotating that element between a first position and a second position is disclosed. The support assembly may be used to support an armrest pad and is suitable for use on watercraft. The assembly includes an arm extending from a knuckle assembly. The arm engages the armrest pad, while the knuckle assembly is disposed in a pocket of a cap assembly. The knuckle assembly rotates within the pocket to move the arm and armrest pad between the first and second positions. A pair of washers and a bushing is abutted with an end of the arm to form the knuckle assembly. The thickness of the washers facilitates a frictional engagement inside the pocket between the knuckle assembly and the cap assembly. Stops are provided to limit the rotational travel of the knuckle within the pocket.

In one aspect, the invention may provide a support assembly adapted to support an armrest pad, the support assembly comprising a pocket defined by a cap assembly; a knuckle assembly rotatably disposed in the pocket; an arm assembly extending from the knuckle assembly; and wherein the armrest pad is secured to the arm assembly.

In another aspect, the invention may provide a support assembly for securing an armrest pad to a supporting structure, said support assembly comprising a cap assembly adapted to be secured to the supporting structure; a pocket defined in the cap assembly; an arm assembly comprising an arm adapted to be secured to the armrest pad; and a knuckle provided on the arm; wherein the knuckle is receivable within the pocket.

In another aspect, the invention may provide a method of moving an armrest pad between a first position and a second position, the method comprising the steps of securing the armrest pad onto an arm assembly extending from a knuckle assembly; disposing the knuckle assembly in a pocket of a cap assembly; securing the cap assembly to a base; and rotating the knuckle assembly within the pocket to move the armrest pad between the first position and the second position.

In another aspect, the invention may provide a method of supporting an element, the method comprising the steps of: securing the element onto an arm assembly extending from a knuckle assembly; disposing the knuckle assembly in a pocket of a cap assembly; securing the cap assembly to a base; and rotating the knuckle assembly within the pocket to move the element.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a side view of an armrest secured to a supporting structure by way of the support assembly in accordance with an aspect of the invention and showing the armrest in a first position;

FIG. 2 is a front perspective view of the support assembly removed from the supporting structure and with the armrest removed therefrom;

FIG. 3 is an exploded front perspective view of the support assembly;

FIG. 4 is an exploded front perspective view of the support assembly taken from a different angle to FIG. 3;

FIG. 5 is a side view of the arm assembly of the support assembly shown alone;

FIG. 6 is a perspective view of the arm assembly;

FIG. 7 is a transverse cross-section taken along line 7-7 of FIG. 2;

FIG. 8 is a longitudinal cross-section taken along line 8-8 of FIG. 2; and

FIG. 9 is a side view of the armrest secured to the supporting structure by way of the support assembly with the armrest in a second position.

Similar numbers refer to similar parts throughout the drawings.

### DETAILED DESCRIPTION

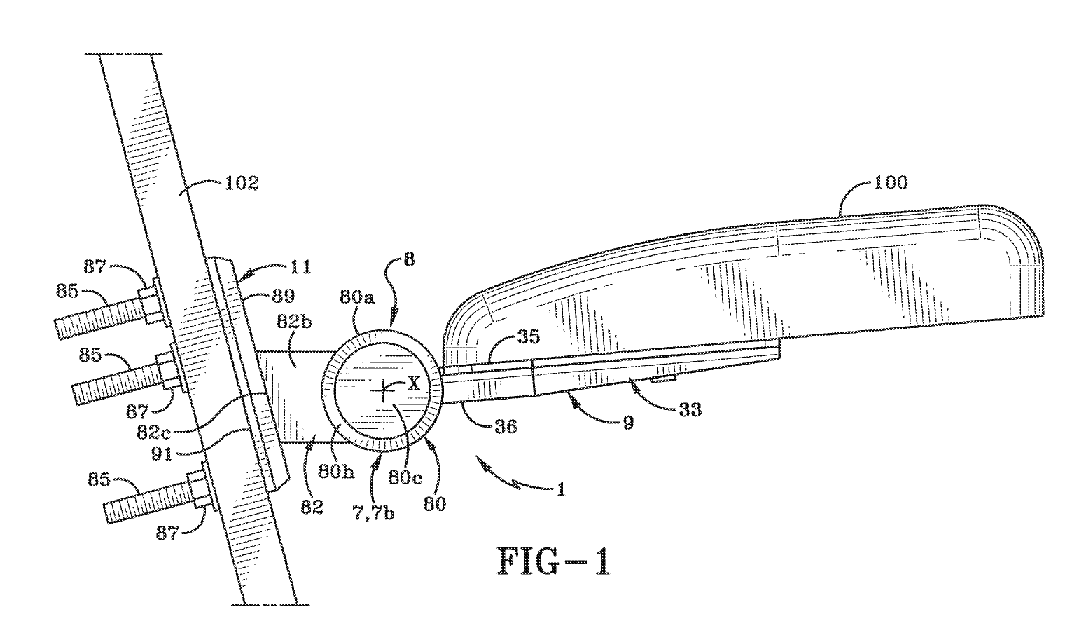

A support assembly is shown in FIGS. 1-9 and referred to generally herein as support assembly 1. Support assembly 1 may be used to secure an armrest pad 100 to a supporting structure 102, as illustrated in FIG. 1. The combined support assembly 1 and armrest pad 100 may, for instance, be mounted on a supporting structure 102 such as a chair backrest or a vertical or semi-vertical wall on watercraft, aircraft or a land vehicle.

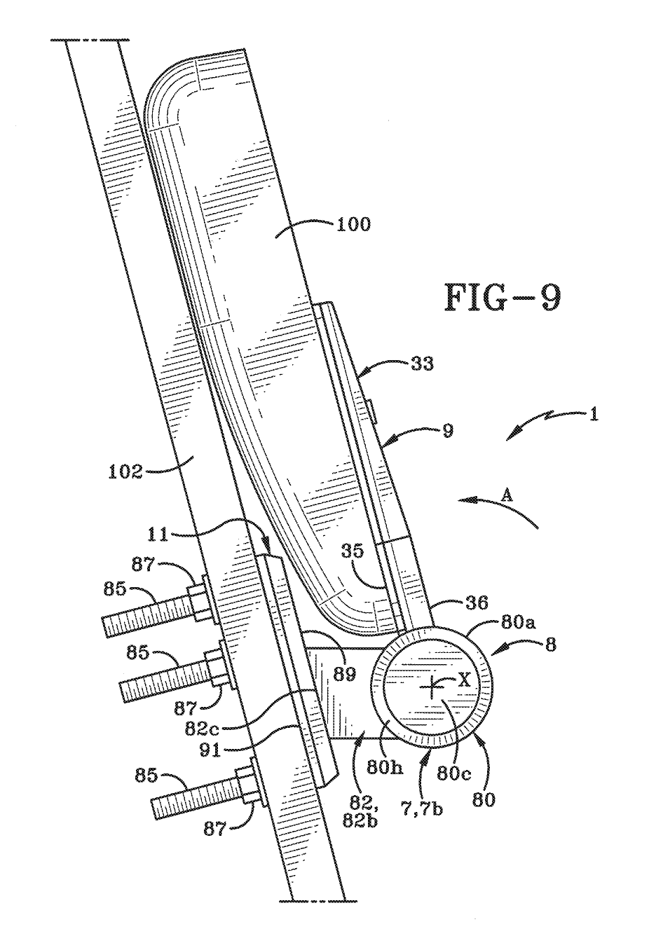

FIG. 1 shows a first part of support assembly 1 and therefore armrest pad 100 in a first position relative to supporting structure 102. In this first position, armrest pad 100 is in a generally horizontal orientation and may be used to support a person's forearm thereon. FIG. 9, on the other hand, shows the first part of support assembly 1 and therefore armrest pad 100 in a second position relative to supporting structure 102. In this section position, the first part of support assembly 1 and therefore armrest pad 100 has been rotated in the direction of arrow “A” and is angled a few degrees off vertical. (Armrest pad 100 may, alternatively, be oriented generally vertically.) In this second position, armrest pad 100 is not able to support a forearm of a person thereon.

In order to move the first part of the support assembly 1 and thereby armrest pad 100 between the first and second positions, a force needs to be applied thereto. Support assembly 1 holds armrest pad 100 in any particular orientation by friction and this friction needs to be overcome in order to rotate support assembly 1. This will be further discussed herein.

As shown in FIGS. 1-9, support assembly 1 includes a bushing 3, a cap assembly 8, an arm assembly 9, and a base 11. Arm assembly 9 includes a first region which engages bushing 3 and cap assembly 8 and is rotatable therein. A second region of arm assembly 9 engages armrest pad 100. Cap assembly 8 is secured to base 11 and base 11, in turn engages, supporting structure 102. All of the components referenced above and their interactions will be described hereafter.

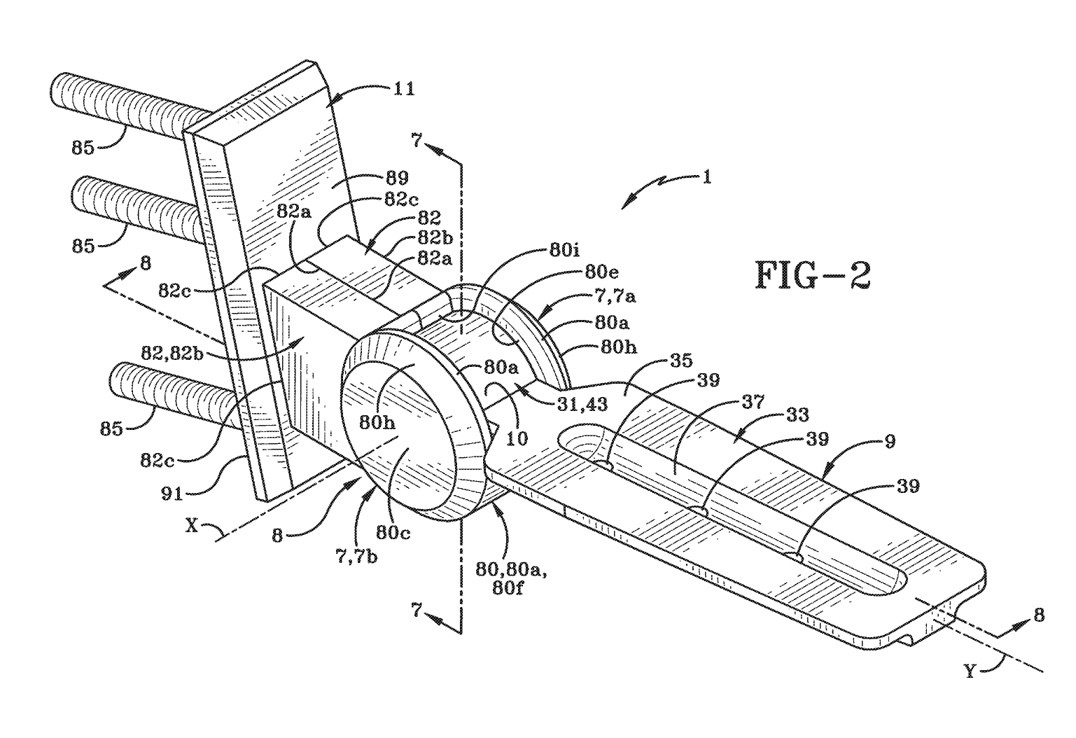

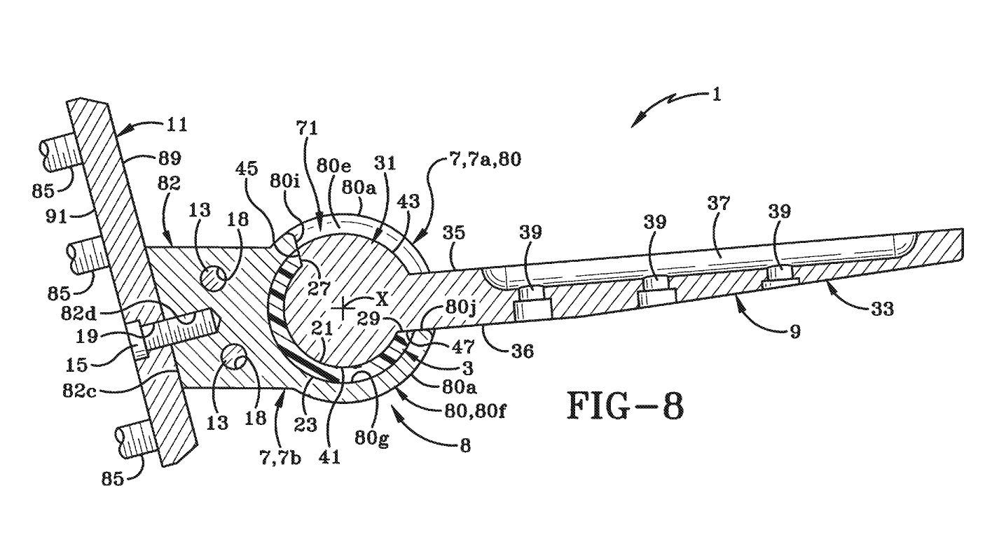

The first region of arm assembly 9 is a knuckle 31 and the second region thereof is an arm 33. Armrest pad 100 is engaged with arm 33 of arm assembly 9. Arm 33 includes a flat planer top surface 35 (FIG. 2) which defines a recess 37 therein. Recess 37 is positioned generally along a longitudinal axis “Y” of arm 33. Recess 37 further defines a series of apertures 39 extending from top surface 35 through to a bottom surface of arm 33 (FIG. 8). When armrest pad 100 is engaged with arm assembly 9, fasteners 104 (FIG. 8) are inserted through apertures 39 and into threaded holes (not shown) in the bottom wall of armrest pad 100. Thus, arm 33 and armrest pad 100 are caused to move in unison with each other when subjected to a force.

Knuckle 31 extends longitudinally outwardly away from a first end 33a (FIG. 2) of arm 33. A pair of angled shoulders 33b, 33c on arm 9 flares outwardly away from either side of an inner region of first end 33a. Knuckle 31 is generally circular in shape when viewed from the side and includes a bottom arc surface 41, a top arc surface 43, a first step surface 45, and a second step surface 47. Bottom and top arc surfaces 41, 43 are generally longitudinally aligned with each other and with arm 33. As shown in FIG. 8, first step surface 45 and second step surface 47 extend between top arc surface 43 and bottom arc surface 41 in a step-like orientation. The shape of knuckle 31 when viewed from the side is substantially identical to one of washers 5. The overall shape of bottom arc surface 41 has a first radius of curvature while the overall shape of top arc surface 43 has a second radius of curvature.

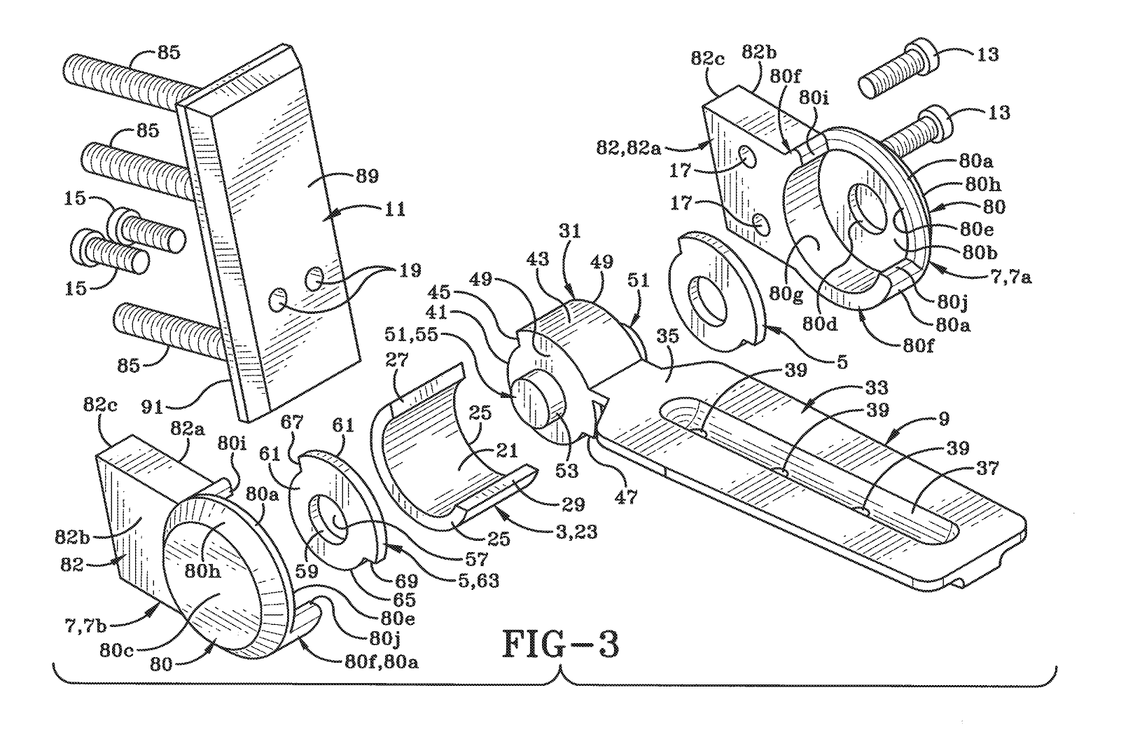

Knuckle 31 further includes a pair of side surfaces 49 which are oriented generally at right angles to top surface 35 of arm 9 and to top and bottom arc surfaces 43, 45. A cylindrical shaped projection 51 extends laterally outwardly away from each side surface 49 of knuckle 31 (FIG. 3). Projections 51 are oriented substantially at right angles to side surfaces 49 and to longitudinal axis “Y” of arm 33. In particular, projections 51 are oriented substantially at right angles to top surface 35 of arm 33. Each projection 51 includes a side surface 53 and a tip surface 55. Projections 51 are aligned along an axis “X”, where axis “X” extends between tip surface 55 of one of the projections 51 and tip surface 55 of the other of the projections 51. Axis “X” is shown in FIGS. 2 and 7.

Projections 51 are complementary in shape and size to the aperture 57 defined in washers 5 and to recess 80d in circular region 80. When arm assembly 9 is engaged with cap elements 7, projections 51 are received through apertures 57 and into recesses 80d in circular regions 80. Projections 51 retain knuckle 31 within pocket 10 and within engagement with cap assembly 8. When arm assembly 9 pivots between the first generally horizontal position and the second generally vertical position, arm assembly 9 pivots about an axis “X” which runs along projections 51.

Knuckle 31 of arm assembly 9 engages bushing 3. As shown in FIG. 3, bushing 3 is generally “C” shaped having an inner surface 21, an outer surface 23, and a pair of side surfaces 25. Extending between each side surface 25 is a first transverse surface 27 and a spaced apart second transverse surface 29. Inner surface 21 is complementary in curvature to bottom arc surface 41 of knuckle 31. Knuckle 31 engages bushing 3 such that bottom arc surface 41 of knuckle 31 is adjacent inner surface 21 of bushing 3. Additionally, first transverse surface 27 of bushing 3 is proximate first step surface 45 of knuckle 31 and second transverse surface of bushing 3 is proximate second step surface 47 of knuckle 31.

Washers 5 are engaged with knuckle 31 and cap assembly 8. As shown in FIGS. 3 & 4, washers 5 are generally circular components. Washers 5 and knuckle 31 on arm assembly 9, when viewed from the side, are substantially identical in shape except one has projections 51 thereon and the other defines an aperture therein, as will be further discussed herein. Each washer 5 has a pair of side surfaces 61 connected by a top arc surface 63 and a bottom arc surface 65. Transitioning between top arc surface 63 and bottom arc surface 65 is a first step surface 67 and a second step surface 69. Again, the curvature of bottom arc surface 65 of washer and curvature of inner surface 21 of bushing 3 is complementary. Each washer 5 also has an inner surface 59 which bounds and defines a generally central aperture 57. Aperture 57 extends between side surfaces 61 and may be generally circular in shape, Aperture 57 of each washer 5 is complementary is size and shape to one of projections 51 on knuckle 31. Washers 5 are thus engaged with projections 51 and are positioned on either side of knuckle 31. When washers 5 are so engaged with knuckle 31 and knuckle 31 is engaged with bushing 3, step surfaces 67, 69 are disposed adjacent transverse surfaces 27, 29 of bushing 3.

In accordance with an aspect of the invention, washer 5 has a width as measured between the two side surfaces 61 thereof. The specific washers 5 selected for engagement with knuckle 31 and bushing 3 are selected based on their width for reasons that will be explained later herein.

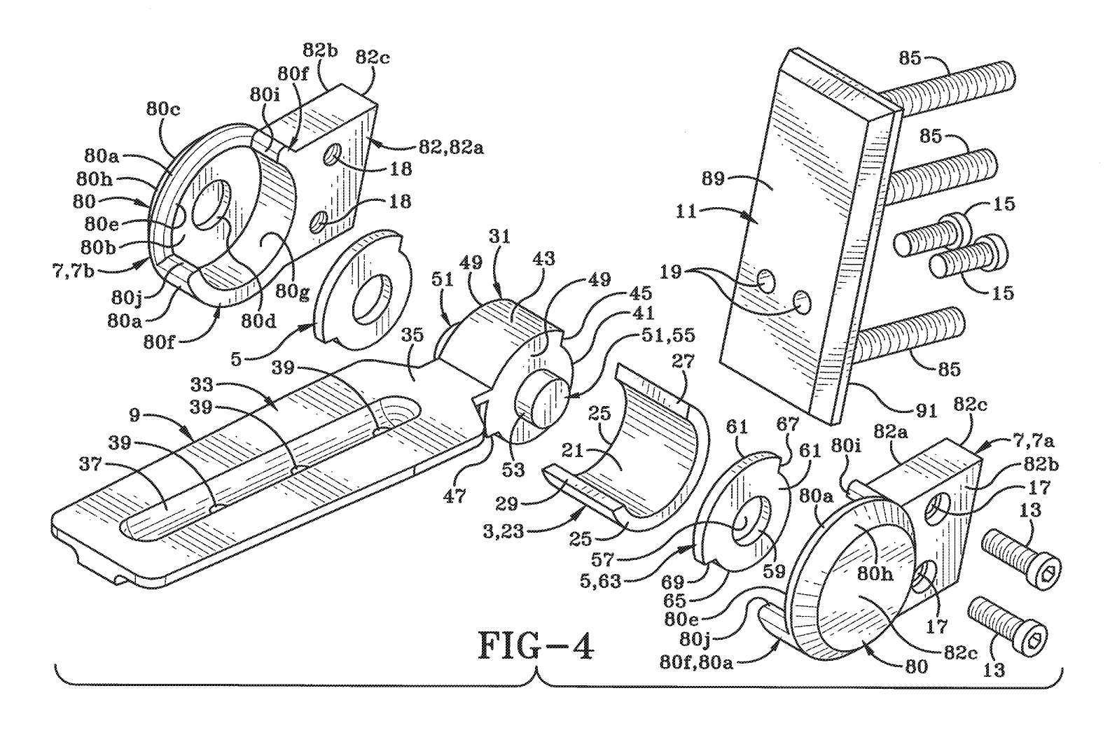

Cap assembly 8 secures arm assembly 9 to bushing 3 and to washers 5. Cap assembly 8 includes a pair of cap elements generally indicated by the reference character 7. Cap assembly 8 further includes a first cap element 7a and a second cap element 7b. Cap elements 7a and 7b are substantially identical but are oriented in cap assembly 8 as mirror images of each other. Cap elements 7a and 7b are positioned in a side-by-side arrangement and are selectively secured together in this configuration. Cap elements 7a and 7b differ from each other in only one aspect that will be described below. Referring to FIGS. 3 and 4, each cap element 7a, 7b comprises a generally circular region 80 and a generally square or rectangular region 82. Rectangular region 82 extends outwardly in a first direction from a circumferential surface 80a of circular region 80.

Circular region 80 has an interior surface 80b and an exterior surface 80c and the circumferential surface 80a extends therebetween. Interior surface 80b defines a centrally located recess 80d and an annular lip 80e spaced from recess 80d. A C-shaped flange extends laterally inwardly from a region of lip 80e and terminates in an inner surface 80f that is spaced from interior surface 80b. An annular curved surface 80g is provided on the C-shaped flange and innermost region of lip 80e. On the flange, surface 80d extends from inner surface 80f to the interior surface 80b. The flange includes a first end 80i and a second end 80j which are oriented generally at right angles to lip 80e. First and second ends 80i, 80j may act as stops to limit the rotation of arm assembly 9, as will be further described herein. Exterior surface 80c of circular region 80 is generally planar except for an annular bezel 80h which angles outwardly from exterior surface 80c to circumferential surface 80a.

Rectangular region 82 includes an interior surface 82a, an exterior surface 82b, and an end wall 82c that extends between interior and exterior surfaces 82a, 82b. End wall 82c is located opposite circular region 80. A threaded recess 82d (FIG. 8) is defined in each end wall 82c. Only one such recess 82d is illustrated in FIG. 8 but it should be understood that the other rectangular region 82 includes a similar recess 82d. Recess 82d extends inwardly from end wall 82c and towards circular region 80, terminating a distance away from circular region 80.

Two apertures 17 (FIG. 3) are defined in rectangular region 82 of cap element 7a. Apertures 17 are spaced a distance vertically apart from each other (with reference to the orientation of the components shown in FIG. 3) and extend between interior and exterior surfaces 82a, 82b. Apertures 17 may be countersunk in exterior surface 82b to accommodate the heads of fasteners 13. A pair of threaded recesses 18 (FIG. 4) is defined in interior surface 82a of cap element 7b. Recesses 18 are spaced a distance vertically apart from each other and each recess 18 is aligned with one of apertures 17 in the other rectangular region 82.

It should be noted that the shape of washer 5 is complementary to the shape of circular region 80 and particularly to curved surface 80g thereof. Each washer 5 is configured to be engaged with curved surface 80g of one of cap elements 7a, 7b. When washer 5 and curved surface 80g are so engaged, second top arc surface 63 becomes circumferentially aligned with an exterior circumferential surface of the C-shaped flange on the associated cap element 7a or 7b. In other words, each washer 5 slots into the circular region 80 such that bottom arc surface 65 abuts curved surface 80g surfaces 80i and 80j are adjacent step surfaces 67, 69. Washers 5 can thus only engage cap elements 7a, 7b in a specific orientation.

Once bushing 3 is engaged with knuckle 31 and washers 5 are engaged therewith, cap elements 7a and 7b are positioned adjacent the exterior surfaces of the two washers 5. Knuckle 31 is thus seated within a pocket 10 (FIG. 2) defined by cap elements 7a, 7b, washers 5 and bushing 3. Cap elements 7a and 7b are secured to each other by a pair of fasteners 13. Each fastener 13 is inserted through one of the apertures 17 on cap element 7b and into the corresponding recess 18 in interior surface 80a of cap element 7a. Fasteners 13 are tightened, thereby clamping knuckle 31, bushing 3, washers 5 and cap elements 7a, 7b together.

As shown in FIG. 7, bushing 3 and washers 5 may be placed in an abutting relationship with knuckle 31 of arm assembly 9 to form a knuckle assembly 71. Specifically, each washer 5 may be oriented such that projections 51 of knuckle 31 extend into apertures 57 of washers 5. This arrangement brings inner surface 59 of knuckle 31 into abutting contact with side surface 53 of projection 51 and one of the side surfaces 61 with side surface 49. Further, top arc surface 43 of arm assembly 9 may be generally aligned with top arc surface 63 of both washers 5 to present a consistently smooth outer surface. Likewise, bottom arc surface 41 may be generally aligned with bottom arc surface 65 to present a consistently smooth outer surface. This entire outer surface comprised of bottom arc surface 41 and bottom arc surface 65 may be enveloped by bushing 3, and specifically abutted by inner surface 21 thereof. Correspondingly, side surfaces 25 of bushing 3 are co-planer with the corresponding outer side surface 61 of each washer 5. As shown in FIG. 7, this creates a generally smooth outer surface on each side of knuckle assembly 71, with the exception of the projections 51 which extend outwardly therefrom. First transverse surface 27 firmly abuts first step surface 45 of arm assembly 9 along with first step surfaces 67 of washers 5. Likewise, second transverse surface 29 firmly abuts second step surface 47 as well as second step surfaces 69. As shown in the figures, cap elements 7 fit together to encapsulate knuckle assembly 71 rotatably in the pocket 10 defined by cap element 7a fitting against cap element 7b.

Base 11 is used to mount support assembly 1 on a surface. Base 11, as illustrated in FIGS. 2-4, is a generally rectangular component having a front surface 89 and a back surface 91 (FIG. 1). The side wall extending between front and back surfaces 89, 91 may be beveled so that base 11 does not present any sharp surfaces. Base 11 may include one or more studs 85 which are integrally formed with or secured to back surface 92. Studs 85 are used to secure base 11 to a suitable supporting structure such as a chair backrest 102 (FIG. 11). Nuts and washers 87 may be engaged with studs 85 for this purpose. Alternatively, base 11 may define one or more apertures therein which extend from front surface 89 through to back surface 91 thereof. Fasteners may be received through these apertures to secure base 11 to the supporting structure 102.

Base 11 further defines one or more apertures 19 therein which extend from front surface 89 through to back surface 91 thereof. Cap assembly 8 may be secured to a base 11 by a pair of fasteners 15 which extend through these apertures 19 and into recesses 82d in rectangular regions 82 of cap elements 7a, 7b.

In operation, support assembly 1 may be configured to secure a support armrest pad 100 to a supporting structure 102 such as a chair backrest. Support assembly 1 facilitates the movement of armrest pad 100 between a first generally horizontal position (FIG. 1) and a second generally vertical position (FIG. 9) relative to supporting structure 102. As seen in FIG. 1, back surface 91 of base 11 abuts supporting structure 102 and the studs 85 extending from base 11 are used to secure base 11 to supporting structure 102.

Armrest pad 100 may be secured to arm 33 or arm assembly 9 before or after base 11 is properly secured to supporting structure 102. As indicated earlier herein, fasteners are inserted through arm 33 and through apertures 39 in recess 37 and into armrest pad 100. Armrest pad 100 is positioned adjacent top surface 35 of arm 33. Once armrest pad 100 is firmly secured to arm 33, pad 100 may be moved in unison with arm 33 between the first position (FIG. 1) and the second position (FIG. 8).

As discussed previously, knuckle assembly 71 may be arranged and configured to be complementary to and received within pocket 10 of cap assembly 8. Pocket 10 may be provided by the combination of the two curved surfaces 80g of cap elements 7a, 7b when cap element 7a is secured to cap element 7b.

In accordance with an aspect of the invention, knuckle assembly 71 may be sized to closely fit within pocket 10. This facilitates the frictional engagement between knuckle assembly 71 and cap elements 7 and thereby aids in controlling the overall resistance of arm assembly 9 with respect to moving between the first position (FIG. 1) and the second position (FIG. 9).

The amount of resistance needed to move arm assembly 9 between the first position and the second position may be controlled by the thickness (i.e., width) or type of washers 5 used inside knuckle assembly 71. It follows that increasing the thickness (width) of washers 5, will tend to increase the overall friction between knuckle assembly 71 and cap elements 7. An increase in friction between knuckle assembly 71 and cap elements 7 necessitates an increase in force required to manually move support assembly 1 and thereby armrest pad 100 between the first position and the second position. When support assembly 1 is fabricated, the thickness of the washers 5 to be used therein will be selected to ensure that knuckle assembly 71 will be frictionally retained within pocket 10 of cap assembly 8 while still being able to rotate smoothly between the first and second positions. The degree of rotation of knuckle assembly 71 relative to cap assembly 8 may be restrained within a certain range. This may be accomplished in the example embodiment of the invention by the arm 33 contacting stops provided on cap assembly 7. These stops may take the form of surfaces 80i and 80j which are located parallel to axis “X”, i.e., the axis of rotation. When upper surface 35 of arm 33 contacts surface 80i the motion in the direction of arrow “A” will be halted. When lower surface 36 of arm 33 contacts surface 80j on cap assembly 7, rotational motion in the opposite direction to arrow “A” will be halted. It will be understood that stops may be provided on one or more of cap assembly 7, arm assembly 9, bushing 3 or washers 5 to accomplish this limitation of the range of rotation of arm 33.

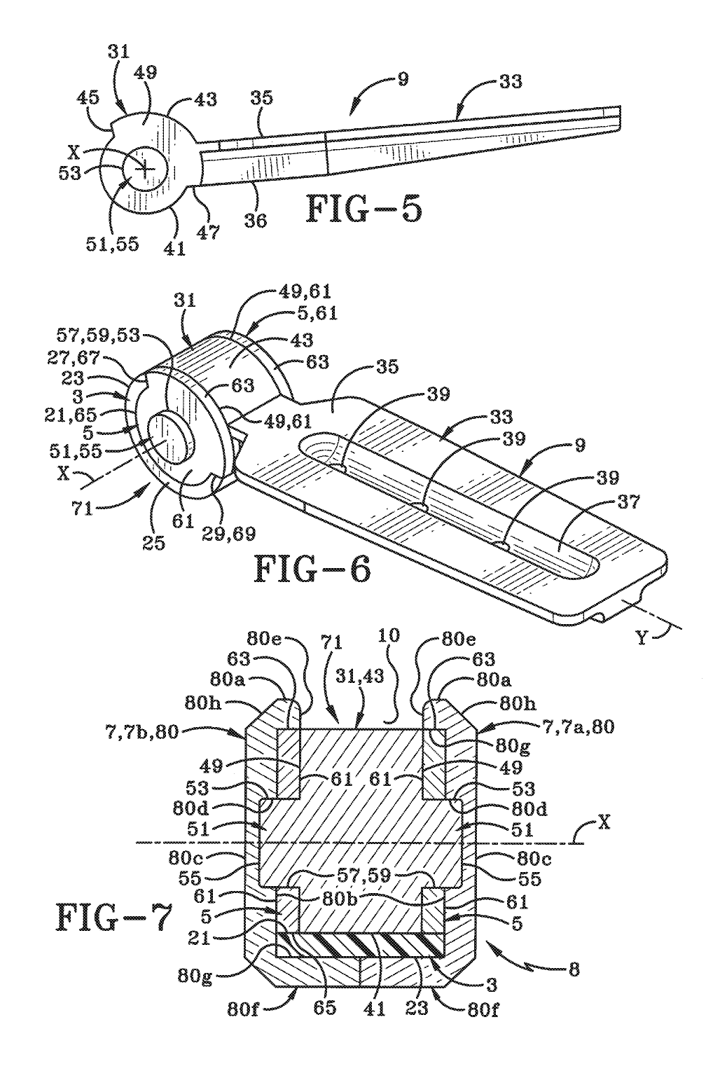

As shown in FIG. 1, cap element 7a may be secured to cap element 7b by way of fasteners 13 extending through apertures 17 of cap element 7a and being received within recesses 18 of cap element 7b. Fasteners 13 are tightened to press cap element 7a against cap element 7b and thereby form cap assembly 8. As shown in FIGS. 5 & 6, knuckle assembly 71 provides a smooth outwardly projecting surface comprised of top arc surface 43 of knuckle 31, top arc surface 63 of washers 5, and outer surface 23 of bushing 3. This smooth outer surface rotates as support assembly 1 moves between the first position and the second position. Consequently, an outwardly facing smooth surface is maintained as support assembly 1 moves between the first position and the second position through the open area defined by cap assembly 8. This provision of this smooth outer surface at all times prevents a substantial amount of debris and moisture from entering cap assembly 8 as the opening provided by cap elements 7 for knuckle assembly 71 may be entirely filled by knuckle assembly 71 throughout the range of movement between first position and second position. Thus, there are no gaps or empty spaces within cap assembly 8 for receiving any additional material apart from knuckle assembly 71.

As shown in FIG. 1, when support assembly 1 is in the first position, top arc surface 43 may generally project outwardly away from cap assembly 8 and prevent debris and moisture from entering therein. As shown in FIG. 9, when support assembly 1 is in the second position, outer surface 23 may project outwardly away from cap assembly 8 to prevent debris and moisture from entering therein. Thus, throughout the entire range of movement, one or more surfaces project outwardly away from cap assembly 8 to prevent debris and moisture from entering therein. This keeps support assembly 1 clear of debris and moisture and functioning at a high level for a long period of time.

It will be understood that in some instances base 11 may be omitted and cap assembly 8 may be directly secured to supporting structure 102 by way of the fasteners 15. In other instances, base 11 and cap assembly 8 may be formed as a single, integral component which is then secured to supporting structure 102.

It will be understood that support assembly 1 may be used in other systems to support different components in vehicles, machinery or equipment. Consequently, any reference herein to assembly 1 being used with an armrest should be broadly interpreted as being equally applicable to other components needing support.

In the foregoing description, certain terms have been used for brevity, clearness, and understanding. No unnecessary limitations are to be implied therefrom beyond the requirement of the prior art because such terms are used for descriptive purposes and are intended to be broadly construed.

While the support assembly has been described in connection with the various figures, it is to be understood that other modifications and additions may be made to the support assembly. Therefore, the present invention should not be limited to any single embodiment of the support assembly, but rather construed in breadth and scope in accordance with the recitation of the appended claims.

1. A support assembly for securing an armrest pad to a supporting structure, said support assembly comprising:
a cap assembly adapted to be secured to the supporting structure;
a pocket defined in the cap assembly;
an arm assembly comprising:
an arm adapted to be secured to the armrest pad; and
a knuckle provided on the arm; wherein the knuckle is receivable within the pocket.

2. The support assembly as defined in claim 1, wherein knuckle is retained within the pocket by friction.

3. The support assembly as defined in claim 1, wherein the knuckle is rotatable within the pocket.

4. The support assembly as defined in claim 1, wherein the arm assembly is rotatable between a first position and a second position; and when in the first position the arm assembly is adapted to hold the armrest pad in a generally horizontal orientation; and when in the second position the arm assembly is adapted to hold the armrest pad in a generally vertical orientation.

5. The support assembly as defined in claim 1, wherein the arm includes a generally planar top surface adapted to be secured to the armrest pad; and the knuckle rotates about an axis disposed at right angles to the top surface of the arm.

6. The support assembly as defined in claim 1, wherein the knuckle includes:
a pair of opposed side surfaces;
a projection extending outwardly from each side surface, said projections being aligned with each other along a common axis; wherein the projections are received within a pair of spaced apart recesses defined in the cap assembly; and wherein the knuckle is rotatable relative to the cap assembly about the common axis.

7. The support assembly as defined in claim 1, wherein the cap assembly comprises:
a first cap element and a second cap element which are positioned in a side-by-side arrangement; wherein each of the first and second cap elements includes:
a first region engageable with the knuckle; and
a second region adapted to be secured to the supporting structure; and wherein the pocket is defined between the first region of the first cap element and the first region of the second cap element.

8. The support assembly as defined in claim 7, further comprising a bushing located between the first and second regions; and wherein the bushing forms part of the pocket in which the knuckle is received.

9. The support assembly as defined in claim 8, wherein the knuckle includes a curved exterior surface, and the exterior surface is complementary in curvature to an inner surface of the bushing and is positionable adjacent the inner surface of the bushing.

10. The support assembly as defined in claim 8, further comprising a pair of washers, where each washer is located adjacent an opposite side surface of the knuckle and between the knuckle and a side wall of one or the other of the first regions of the first and second cap elements.

11. The support assembly as defined in claim 8, wherein the first region of each of the first and second cap elements includes:
a side wall;
a flange extending outwardly from the side wall;
an annular groove defined by the side wall and the flange; and
wherein the bushing is engaged in the annular grooves of the first and second cap elements.

12. The support assembly as defined in claim 8, further comprising a stop provided on one or both of the first regions of the first and second cap elements; said stop limiting the degree of rotation of the knuckle within the pocket.

13. The support assembly as defined in claim 1, further comprising a base adapted to secure the cap assembly to the supporting structure; wherein the base includes a front wall, a rear wall and side walls extending between the front and rear walls; and the cap assembly is engaged with the front wall and extends outwardly and forwardly away therefrom; and the rear wall is adapted to abut an exterior surface of the supporting structure and is securable thereto.

14. The support assembly as defined in claim 13, wherein the base is free of fasteners which are accessible on the front wall or side walls of the base.

15. The support assembly as defined in claim 14, further comprising one or more studs which extend outwardly from the rear wall of the base; said studs being adapted to be received through apertures in the exterior surface of the supporting structure.

16. The support assembly as defined in claim 1, further comprising a pair of washers located within the pocket of the cap assembly on either side of the knuckle; and wherein the knuckle includes a pair of projections extending outwardly therefrom in opposite directions and each projection passes through an aperture defined in the associated washer and is received within a recess defined in an interior wall of the cap assembly.

17. The support assembly as defined in claim 16, wherein the projections are aligned along a common axis and the knuckle rotates about that axis between a first position and a second position.

18. The support assembly as defined in claim 17, wherein the washers are selected from a group of washers of different thicknesses, and the thickness of the selected washers positioned adjacent the knuckle is such that the knuckle is tightly retained in the pocket by friction.

19. A method of moving an armrest pad between a first position and a second position, the method comprising the steps of:
securing the armrest pad onto an arm assembly extending from a knuckle assembly;
locating the knuckle assembly in a pocket of a cap assembly;
securing the cap assembly to a base;
securing the base to a supporting structure; and
rotating the knuckle assembly within the pocket to move the armrest pad between the first position and the second position.

20. A method of supporting an element, the method comprising the steps of:
securing the element onto an arm extending from a knuckle assembly;
locating the knuckle assembly in a pocket of a cap assembly;
securing the cap assembly to a base;
securing the base to a supporting structure.

21. The method as defined in claim 20, further comprising the step of selectively rotating the knuckle assembly within the pocket to move the element between a first position and a second position.
